(19) United States
(12) Patent Application Publication
(10) Pub. No.: US 2025/0307548 A1
(43) Pub. Date: Oct. 2, 2025

(54) PRESERVING STATIC CONTENT IN GENERATIVE AI APPLICATIONS USING LARGE LANGUAGE MODELS

(71) Applicant: NVIDIA Corporation, Santa Clara, CA (US)

(72) Inventors: Chandana NEERUKONDA, Santa Clara, CA (US); Rajath SHETTY, Sunnyvale, CA (US); Peng XU, Santa Clara, CA (US)

(21) Appl. No.: 18/618,788

(22) Filed: Mar. 27, 2024

(51) Int. Cl. G06F 40/284; G06N 3/0895

(52) U.S. Cl. CPC G06F 40/284; G06N 3/0895

(57) ABSTRACT

Embodiments of the present disclosure relate to using or generating a token and/or tokenized representation representative of a set of content, which may help in alleviating hallucination and other problems described herein. In operation, at inference time, some embodiments may first provide a representation of first natural language characters as an input into a machine learning model. The machine learning model may then responsively generate a tokenized representation based on the first natural language characters. The tokenized representation may not include a same character sequence as the set of content. Subsequent to the generation of the token and/or tokenized representation, some embodiment retrieve, via a data structure, the set of content.

### BACKGROUND

Computational linguistics, also known as Natural Language Processing (NLP), is a computer-based technique to understand, learn, and/or generate content (e.g., text) in a language, such as English. Recent advances in NLP technologies use sophisticated language models to derive a rich understanding of natural language. For example, Large Language Models (LLMs) can perform Natural Language Generation (NLG), a process that generates output in one or more natural languages that can be used in many downstream tasks such as text summarization, dialogue generation, generative question answering (GQA), data-to-text generation, and machine translation.

However, LLMs and other machine learning models can be susceptible to generating natural language text that is nonsensical, inaccurate, unfaithful to the provided source input, or is otherwise incorrect, which is referred to as “hallucination.” In an illustrative example, a user may input a prompt to request the model to return a particular Hypertext Transfer Protocol (http) link. However, the model may return an http link that appears similar to a genuine URL address for a webpage that does not actually exist or is otherwise incorrect. Hallucination is concerning because it can provide undesirable output and impact user experience.

### SUMMARY

Embodiments of the present disclosure relate to using or generating a token (e.g., a string sequence “LINK_1”) representative of a set of content (e.g., a full http link, such as “http://www.abc.edu”), which may help in alleviating hallucinations of static content produced by generative artificial intelligence techniques, particularly those that use denoising and randomization. In operation, at inference time, some embodiments may first provide a representation (e.g. a soft prompt) of first natural language characters (e.g., a question) as an input into a machine learning model (e.g., an LLM). The machine learning model may then responsively generate a tokenized representation (e.g., a token identifier that represents a token) as its output response based on the first natural language characters. The tokenized representation may be representative of any suitable full language model set of content (e.g., any immutable content, such as a link, predefined factual information, source code, etc.). But the tokenized representation may not include a same character sequence as the set of content. In an illustrative example, the machine learning model may first receive a user question, request, or command in natural language to return a link to a particular website. Responsively, based on ingesting the natural language command, the machine learning model may then generate and return the tokenized representation (e.g., “LINK_1”) that represents the link instead of the full output link itself.

Subsequent to the generation of the tokenized representation, some embodiments may retrieve, via a data structure, the full set of content. For example, the data structure may be a key-value pair structure, such as an index table or a lookup table, where the key is a token that the tokenized representation represents and the value is the full set of content. And based at least on the retrieving, some embodiments may cause presentation of the full set of content (e.g., but not the tokenized representation itself). For example, using the illustration above, the token “LINK_1” may be mapped, via a lookup data structure, to a full http link (e.g., “http://www.abc.edu”), where the full http link is provided to a user device responsive to the initial command by the user.

The use of a token may help alleviate hallucination or other model problems. This may be because a valid output response is always returned or returned more often (e.g., because of the data structure that maps the token to the full output response). This is useful where the model's generated output includes immutable content that should not be modified (e.g., as part of a randomization process or step during content generation), but the model has no way of verifying if the immutable content is correct in its generative output. For example, using the illustration above, the full http link may always be produced at the output for the given command, as opposed to a fabricated link that is generated as a part of the model's generative output capabilities. In other words, the model's generative output response may always or more often contain the full output response because the token is always mapped to the full and correct output via the data structure.

### BRIEF DESCRIPTION OF THE DRAWINGS

The present systems and methods for subcutaneous authentication are described in detail below with reference to the attached drawing figures, wherein:

FIG. 1 is a block diagram of an example token generation pipeline, in accordance with some embodiments of the present disclosure;

FIG. 2 is a block diagram of a Large Language Model that uses particular input(s) to generate particular token(s), in accordance with some embodiments of the present disclosure;

FIG. 3 is a schematic diagram illustrating how a neural network generates a token, in accordance with some embodiments of the present disclosure;

FIG. 4 illustrates an example data structure used for mapping a token to a full output response, in accordance with some embodiments of the present disclosure;

FIG. 5 is a flow diagram of an example process for training a machine learning model to produce a token, in accordance with some embodiments of the present disclosure;

FIG. 6 is a flow diagram of an example process for using a token to present an output response via one or more machine learning models, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

A language model, such as an LLM, may be trained on vast amounts of data obtained from a variety of sources (e.g., by crawling several websites). Such data may contain several types of text that represent information that is generally static or otherwise immutable in nature, including physical addresses, dates, hashes, http links, and the like. The model may use such training data to generate its output response. However, the output responses of LLMs or other existing NLP-based models may be incomplete or inaccurate because they may produce certain undesirable effects, such as hallucination. Hallucination occurs when a language model produces a seemingly reasonable output that is not correct. In other words, hallucination refers to mistakes in the output, such as generated text, which may be semantically or syntactically plausible (e.g., the generated text forms a correctly structured sentence or http link) but is in fact incorrect or nonsensical, which misleads the user.

In an illustrative example of hallucination, a user may issue a question in an LLM prompt, such as “What is the link to sign up for Medicare?” The LLM may responsively generate (based on its training sets of other web addresses) an http link in the output response, such as “https://www.medicare.gov/sign-up-change-plans/how-to-sign-up-for-medicare.” However, such a link may not exist and is thus invalid (e.g., its domain name does not exist and/or the path to the resource (e.g., /page) does not exist). With respect to links and other immutable content (e.g., source code, predefined factual information (e.g., math equations, business addresses), predefined text (e.g., a poem), or an image), one problem is that the model may comingle or conflate at least some incorrect generative output text with other correct immutable content that may require strict accuracy. When formulating the output response, the model may extract the most important and relevant information from the training data sources, such as definitions, examples, explanations, statistics, or opinions. This can be done by using natural language processing techniques, such as named entity recognition, sentiment analysis, or summarization. The model may then synthesize the information into a coherent and concise answer. However, such coherent and concise answer may still only contain a portion (or none) of the correct immutable content and the rest of the immutable content may be missing, making the output invalid. Further, the model may have no verification mechanism to check whether the immutable content output response, such as a link, is correct. In the example above, for instance, the link is not valid (e.g., because the link was not in the training data sources). But the model still tries to formulate an answer because of its language generation responsibilities. Using the example above, for instance, the model may have generated a meaningful phrase, such as “how-to-sign-up-for-medicare” based on the input prompt because it learned to associate such phrases with links from examples in its training dataset(s), but this may not be indicative of a valid link. In other examples, the model may hallucinate by using NLP to extract the wrong links from the training data. In these examples, the links may be valid, but they are not what the user has requested. Another example of an undesirable outcome in similar scenarios is where an LLM produces a response (e.g., http link, web address, etc.) that was previously accurate, but is no longer current. For example, a web domain may lose or abandon its registration, or a webpage may have an updated URL address than what was represented in the dataset(s) used to train the LLM, and producing such links may negatively impact the user experience.

Embodiments of the present disclosure relate to using or generating a token and/or a tokenized representation (e.g., a string sequence “SOURCE CODE_1”) representative of a full language model output response or set of content (e.g., a full source code line or statement, such as “if num % 2==0:print(f″ {num} is an even number . . . ”), which may help in alleviating the hallucination problems described above or other problems. In operation, at inference time, some embodiments may first provide a representation of first natural language characters as an input into a machine learning model (e.g., an LLM). The machine learning model may then responsively generate a tokenized representation as its output response based on the first natural language characters. The tokenized representation may be representative of second natural language characters (e.g., any immutable content). In one or more embodiments, the tokenized representation may not include a same character sequence as the second natural language characters. For example, the first natural language characters may include a user question or command for the model to return source code that performs a particular function (e.g., in PYTHON). The tokeninzed representation or token in one or more embodiments, may be a condensed string sequence representing the source code line or statement, such as “SOURCE CODE_1.” The second natural language characters may correspond to the source code line or statement itself (e.g., “if num % 2==0:print(f″ {num} is an even number . . . ”).

Subsequent to the generation of the tokenized representation, some embodiment may retrieve, via a data structure, the second natural language characters. For example, the data structure may be a lookup table, where the key is a token that the tokenized representation represents, and the value is the one or more second natural language characters. And based at least on the retrieving, some embodiments cause presentation of the second natural language characters (e.g., but not the token itself). For example, a full source code line or statement as described above may be provided to a user since that is what the user asked for in the natural language command.

The use of a token may help alleviate hallucination or other model problems. This may be because a valid output response or immutable content is always returned or returned more often (e.g., because of the data structure and/or the mapping of the token to the full output response). For example, using the illustration above, the full source code line or statement may always be produced at the output for the given prompt, as opposed to a made up source code line or statement that may typically be a part of the model's generative output response. In other words, the model's generative output response may always contain the full correct output response because the token is always mapped to the full and correct output via the data structure. Additionally or alternatively, the token may contain fewer natural language characters relative to full model output responses and/or it contains characters that do not resemble normal natural language (e.g., a hash such as 185f8db32271fe25f561a6fc938b2e264306ec304eda518007d1). In this way, the model may be more unlikely to comingle or conflate correct output responses with other wrong candidate output responses because of how different the token may be from normal regular natural language characters. This may also make it easier for the model to learn a relationship between the token and prompt in training. The use of a token thus improves model performance, such as accuracy.

Before model inference time, various embodiments fine-tune, prompt-tune, and/or prompt engineer the machine learning model to help formulate the best, optimal, or suitable tokenized representation for a given prompt. For example, with respect to fine-tuning and/or prompt-tuning, the model may learn a relationship between a prompt (e.g., a question that requests a specific link) and the tokenized representation (e.g., a hash representing the link). Conversely, the model may not learn a relationship between the prompt and the full model response output (e.g., a full link). Specifically, the model may adjust its weights after various epochs of training at acceptable loss levels in order to learn which tokenized representation belongs to which prompt. In this way, at inference time, the model may simply generate the tokenized representation based on its training and then the post-processing step of mapping (e.g., via an index table) the corresponding token to the full output response can occur.

In some embodiments, the functionality described herein is performed as a part of ego-machine (e.g., vehicle) or simulation operations, such as a control system for an autonomous or semi-autonomous machine, a perception system for an autonomous or semi-autonomous machine, and/or a system for performing simulation operations. Ego-machines, such as cars, may include technologies (e.g., smart speakers) that use language model capabilities. When operators (e.g., drivers) of an ego-machine request generative output response immutable content, such information must be correct with little to no hallucination in order to ensure the operator is focused on the environment for the safety of the operator and others. For example, if a driver continuously receives hallucinated output responses (e.g., an incorrect street address of a destination), the driver may have to repeatedly issue verbal commands or look at a display screen, which may divert the driver's attention from their driving responsibilities, thereby increasing the likelihood of a car accident. The use of a token, as described herein, however, may help improve model performance, such as accuracy so as to reduce the likelihood of hallucination. Consequently, the driver's attention does not have to be diverted as often from their driving responsibilities.

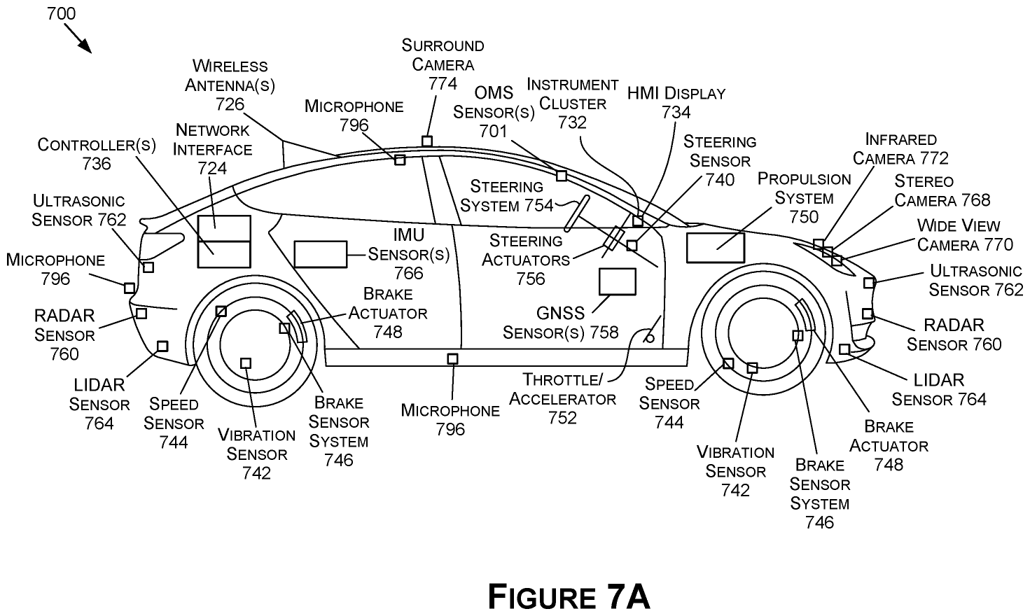

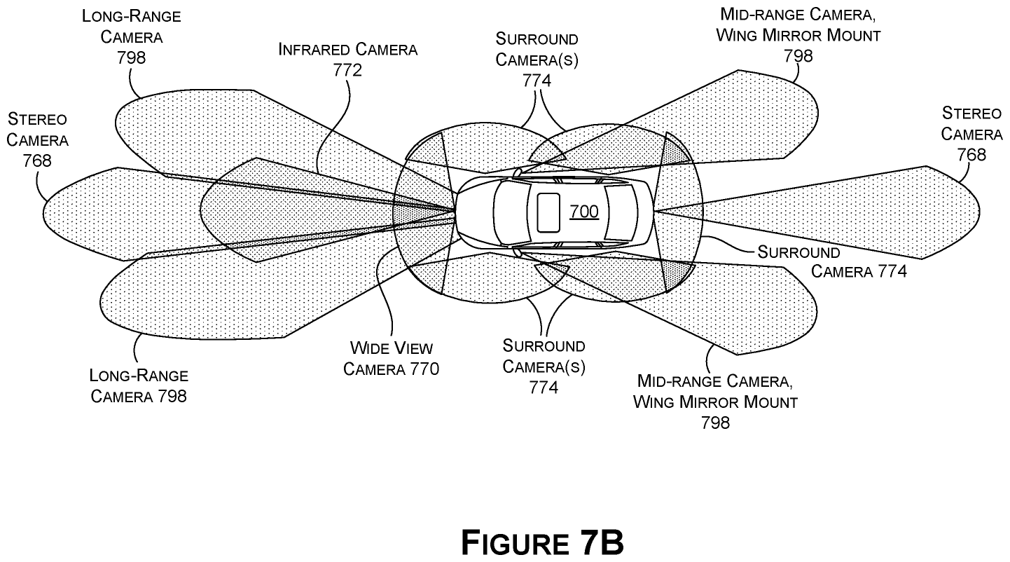

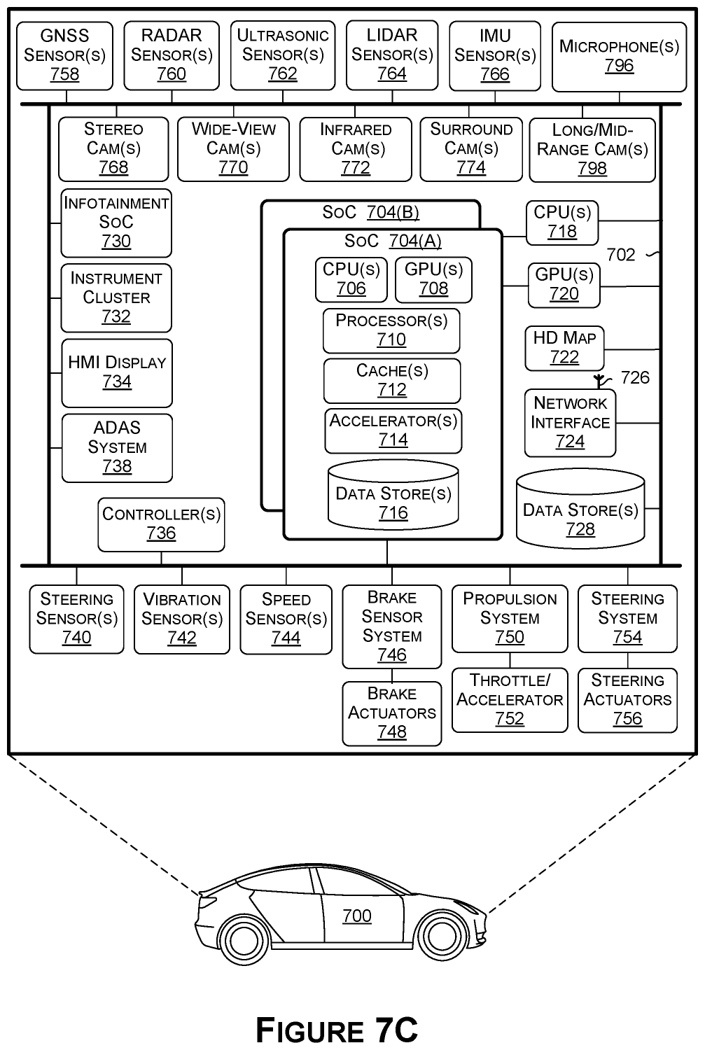

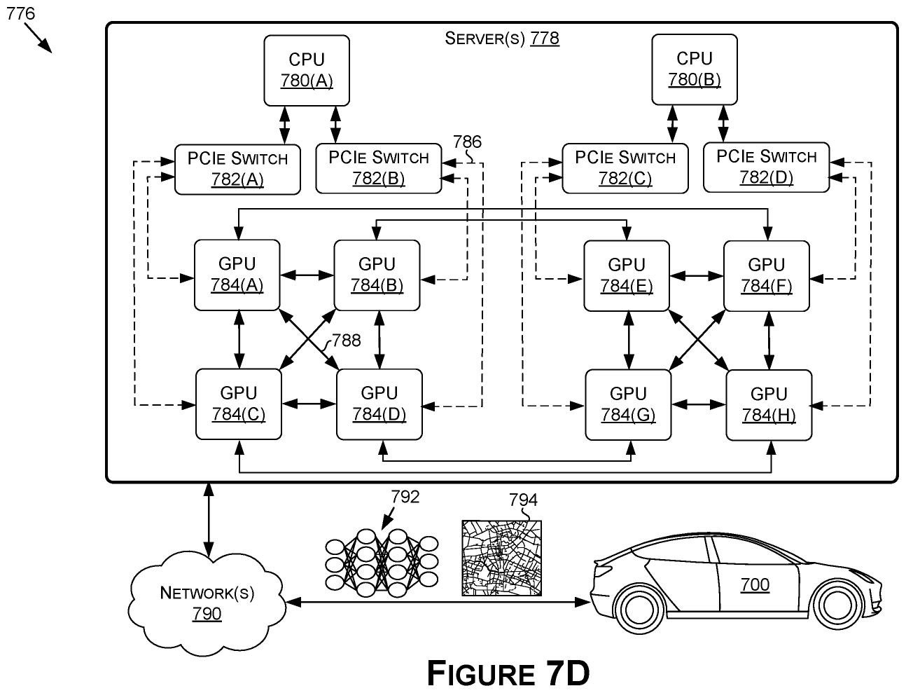

Although the present disclosure may be described with respect to an example autonomous or semi-autonomous vehicle or machine 700 (alternatively referred to herein as “vehicle 700” or “ego-machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to models that generate natural language responses based on extracting natural language information from object(s) and/or detecting the alertness level of an operator, this is not intended to be limiting, and the systems and methods described herein may be used in augmented reality, virtual reality, mixed reality, robotics, security and surveillance, autonomous or semi-autonomous machine applications, and/or any other technology spaces where authentication may be used.

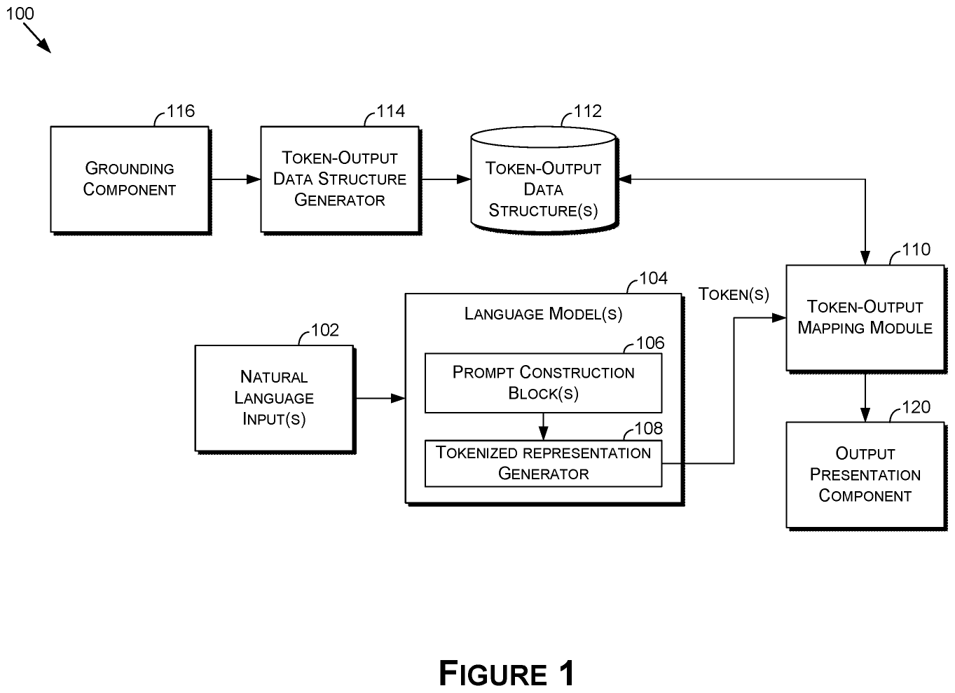

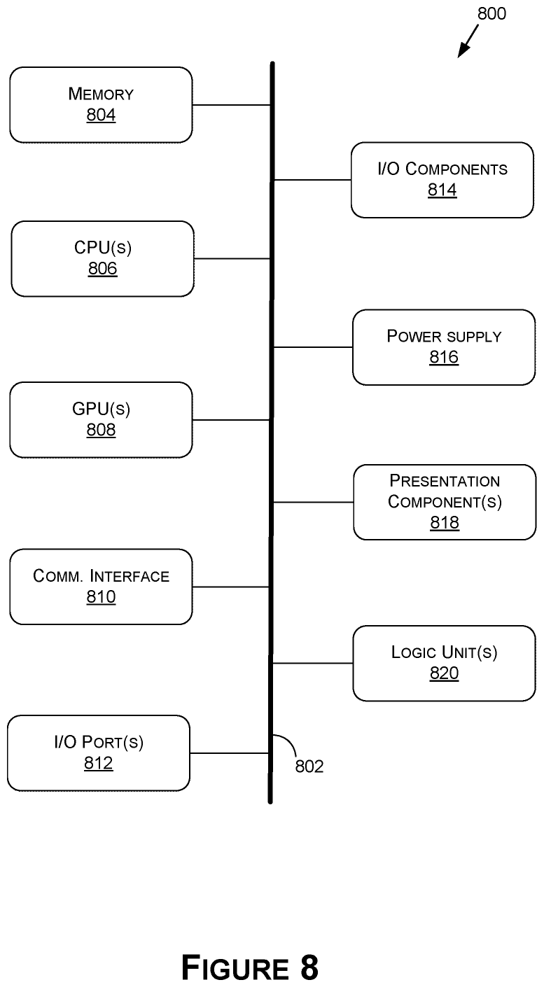

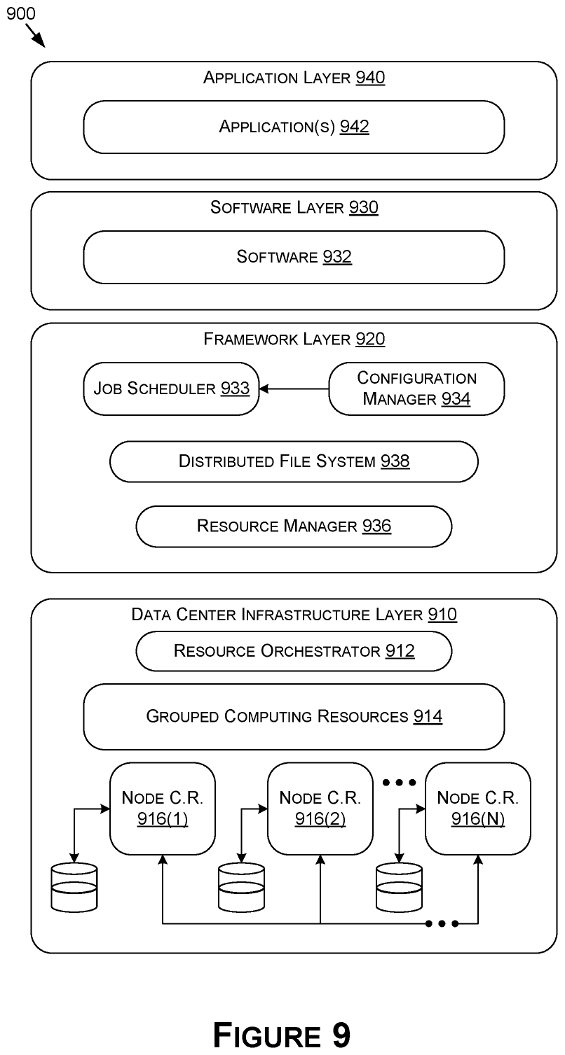

With reference to FIG. 1, FIG. 1 is a block diagram of an example token generation pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 700 of FIGS. 7A-7D, example computing device 800 of FIG. 8, and/or example data center 900 of FIG. 9.

In the embodiment illustrated in FIG. 1, the token generation pipeline 100 includes one or more natural language input(s) 102, one or more language models 104, a token-output mapping module 110, token-output data structure(s) 112, a token-output data structure generator 114, a grounding component 116, and an output presentation component 114. In some embodiments, the token generation pipeline 100 represents model inference time (e.g., after a model has been trained and deployed), runtime, and/or offline functionality (e.g., the grounding component 116 and/or the token-output data structure generator 114 may run offline or not at inference).

The one or more natural language input(s) 102 may be any suitable input that includes one or more human language characters (e.g., English words). For example, the natural language input(s) 102 can be a command or question input by a user (e.g., an ego-machine operator), such as “give me a link of Company A's main website.” In some embodiments, the natural language input(s) 102 additionally or alternatively represent machine-generated inputs, such as prompt templates (which are described in more detail below), or any other natural language instruction to provide immutable content, such as source code, a predetermined fact (e.g., “what is the address of store A?”), a predetermined text (e.g., “generate THE RAVEN poem”), etc.

The language model(s) 104 may be responsible for taking, as input, the natural language input(s) 102 in order to generate one or more token representations based on processing the natural language input(s) 102. In some embodiments, the language model(s) 104 represents one or more machine learning models or other models that perform NLP. In some embodiments, a “language model” is a set of statistical or probabilistic functions that (e.g., collectively) performs Natural Language Processing (NLP) in order to understand, learn, and/or generate human natural language content. For example, a language model may be a tool that determines the probability of a given sequence of words occurring in a sentence (e.g., via Next Sentence Prediction (NSP) or MLM) or natural language sequence. Simply put, it may be a tool that is pre-trained to predict the next word in a sentence or other natural language character set. However, instead of predicting the next word in a sentence, the language model(s) 104 may be trained or tuned to generate a token, as described in more detail below.

A language model is referred to as a large language model (“LLM”) when it is trained on enormous amounts of data. Some examples of LLMs are GOOGLE's BERT and OpenAI's family of generative pre-trained transformer (GPT) networks, which include GPT-2, GPT-3, and GPT-4. GPT-3, for example, includes 175 billion parameters trained on 570 gigabytes of text. These models have capabilities ranging from writing a simple essay to generating complex computer codes-all with limited to no supervision. Accordingly, an LLM is a deep neural network that is very large (e.g., billions to trillions of parameters) and understands, processes, and produces human natural language from being trained on massive amounts of text. These models predict future words in a sentence based on sentences in the corpus of text they were trained on, allowing them to generate sentences which can be similar to how humans talk and write. In some embodiments, the LLM is pre-trained (e.g., via NSP and MLM on a natural language corpus to learn English), prompt-tuned, fine-tuned, and/or functions via prompt engineering, as described in more detail below.

In some embodiments, at least one of the language model(s) 104 is stored locally at a network device or node within the ego-machine. This may be useful for local processing where real-time decisions need to be made while the operator is driving, for example. In these contexts, a reduction in processing latency is desired in order to meet the time constraints related to near real-time operator driving and tasks. Alternatively or additionally, in some embodiments, at least one of the language model(s) 104 is hosted at a remote device, such as a cloud node or central server. In these embodiments, for example, such cloud node or central service may be contacted via a network (e.g., the internet) in order to provide model outputs. Such network architecture may be useful where, for example, heavy data processing is required or lots of data is stored.

The language model(s) 104 includes one or more prompt construction blocks 106 and a token generator 108. The prompt construction block(s) 106 may be responsible for generating (e.g., automatically) or receiving one or more natural language instructions based on the input received from the natural language input(s) 102. The prompt construction block(s) 106 generates natural language characters (or representations thereof, such as a soft prompt) as input into the language model(s) 104, which is used as input by the tokenized representation generator 108. The tokenized representation generator 108 generates, as an output, one or more tokenized representations, which represent an output (e.g., second natural language characters or an image) and one or more corresponding tokens at 112.

In some embodiments, the prompt generated by the prompt construction block(s) 106 may additionally or alternatively include (or be supplemented with) a zero-shot, one-shot, or few-shot examples of representative input-output pairs (e.g., natural language question (input) and token (output) pairs). As described herein, in some embodiments, an “example” refers to one or more model (e.g., representative or exemplary) inputs and/or outputs associated with the natural language input(s) 102, where the output at least partially indicates how the token should be formatted (e.g., via sentence structure or syntax, word choices, length (e.g., number of words) in the output, etc.) according to an example input. In some embodiments, an “example” refers to natural language content that a model uses as a guide for structuring or styling its output, and the model typically does not use the example as a guide for deriving substantive natural language text (e.g., the subject or object in a sentence) in the example to copy over to the output. For instance, if the natural language input(s) 102 contains the phrase, “give me the main Medicare Website,” an example is an input-output pair, such as “retrieve Medicare website” (the example input) and “LINK_1 . . . ” (the example output, which is a tokenized representation).

In some embodiments, the prompt includes (or is supplemented with) entity data, such as a tag that describes particular entities in the natural language characters in the natural language input(s) 102 and/or examples. For example, the tag may be generated via Named Entity Recognition (NER). NER is an information extraction technique that identifies and classifies tokens/words or “entities” in natural language text into predefined categories. Such predefined categories may be indicated in corresponding tags or labels. Entities may be, for example, names of people, specific organizations, specific locations, specific times, specific quantities, specific monetary price values, specific percentages, specific pages, and the like. Likewise, the corresponding tags or labels may be specific people, organizations, location, time, price (or other invoice data) and the like. In an illustrative example of NER functionality, if NER tags an entity (e.g., Thomas Edison) as a “name entity,” this triggers a certain phrase in the prompt, such as “Thomas Edison [name] invented light bulb [incandescent light bulb]” where the information in the brackets represents NER entities to be included in the prompt.

In some embodiments, and as described in more detail herein, the prompt constructed by the prompt construction block(s) 106 represents “hard” and/or “soft” prompts. For example, a prompt template (e.g., a “hard” prompt) may be used at runtime or when the model is deployed. A prompt template is a pre-written text that may be placed before (or used with) a user's input to guide the model to perform a specific task or generate a desired output. For example, a prompt template for summarizing a news article could include a user input (e.g., the natural language input(s) 102), such as “what is this news article about” and the prompt template, which says, “summary” or “Please write a short summary of the following article.” In some embodiments, such templates leave certain words in the prompt template blank because the blank space may depend on the use case provided by the runtime prompt. For example, the template may read, “ . . . for the next_hours . . . ” Such templates may be performed based on performing NLP of the user's input to map it to the correct template.

The language model(s) 104 may ingest the prompt and responsively generate, via the tokenized representation generator 108, an output of one or more tokenized representations according to a confidence interval. Using the example illustration above, where the natural language input(s) 102 include the phrase, “give me a link of Company A's main website.” Responsively, the prompt construction block(s) 106 formulate a prompt and the tokenized representation generator 108 may generate a tokenized representation, such as “LINK_1,” which is not a link itself, but representative of such link. Additionally, in some embodiments, the tokenized representation generator 108 may generate a score indicative of the confidence of the correct tokenized representation given the prompt. Examples of various natural language inputs, prompts, and outputs are described in more detail below.

The tokenized representation generator 108 is responsible for generating and then returning (e.g., in response to a programmatic call from the token-output mapping module 110) the one or more generated tokenized representations to the token-output mapping module 110. The token-output mapping module 110 (which may not be a part of the language model(s) 104) is responsible for mapping (e.g., associating) such received tokenized representation(s) from the tokenized representation generator 108 to a set of content (e.g., one or more second natural language characters) by accessing (e.g., from computer memory) one or more of the token-output data structure(s) 112. In some embodiments, the token-output data structure(s) 112 includes any suitable data structures, such as an index table, a hash table, a lookup table, and/or a pointer between the token and the output. For example, where a hash table is used, the token-output mapping module 110 may search for a specific value with a unique identifier (i.e., the “token”) called a key (e.g., “LINK_1”) that matches content of the tokenized representation(s) output by the tokenized representation generator 108. In a hash map, keys are used to retrieve corresponding output values (e.g., “www.OMNIORION . . . ”. The hash map process may involve a hashing function that takes the key as input and generates an index where the associated value is stored within the data structure.

The token-output data structure generator 114 is generally responsible for generating and updating (e.g., via the grounding component 116) the token-output data structure(s) 112. For example, the token-output data structure generator may generate a lookup table of multiple tokens (keys) and output (values), where each entry represents a respective a token-output pair—a token and the output it represents.

The grounding component 116 is generally responsible for grounding data so that the token-output data structure generator 114 generates up-to-date tokens and/or outputs mapped to such tokens. “Grounding” refers to the process of providing information to the token-output data structure generator 114 based on the most recent and reliable data available at a given time. Grounding is useful for ensuring that the information output is accurate and up-to-date based on the model's training data. For example, a website/http link may become invalid due to an expired web address domain. If the domain associated with the link expires or is no longer renewed by the owner, the link will become invalid. In this situation, the grounding component 116 may invalidate (e.g., delete) a corresponding entry (i.e., a token-output pair) or just the output in the token-output data structure(s) 112 so that the output is not returned to the token-output mapping module 110 and is therefore presented via the output presentation component 120. Rather, for example, the token-output mapping module 110 may receive a response after accessing the token-output data structure(s) 112 that the corresponding entry has been invalidated and then forward such message to the output presentation component 120 so that corresponding indicia can be presented to the user, such as “the link you requested is no longer valid.” In another example, a link may be invalidated based on server errors. Temporary server issues or permanent shutdowns can render a website inaccessible, leading to broken links, which may also be communicated to the presentation component 120.

In some embodiments, grounding data in the context of machine learning may involve training a model on a comprehensive and diverse dataset that represents the most accurate and relevant information (e.g., outputs, such as valid links) available at the time. This dataset serves as the foundation for the model's understanding of various topics, patterns, and relationships between data points. During training, the model may learn to make predictions, generate tokenized representations, or perform tasks based on the patterns it identifies in the training data. This process enables the model to generate accurate and relevant tokens based on the information it has learned. However, after the training phase, the model may not have direct access to real-time data. It relies on the information it has been trained on and may not be continuously updated with new information from the internet or external sources. Grounding data may refer to ensuring the model is trained on a diverse, comprehensive, up-to-date, and representative dataset so that it can provide accurate information based on that knowledge. The token-output mapping module 110 returns and passes the mapped output received from the token-output data structure(s) 112 to the output presentation component 120.

The presentation component 120 is generally responsible for causing presentation of the output (e.g., transmitting the output to an audio or display device) For example, in some embodiments, “presentation” involves generating audio data representing one or more second natural language characters, such as a full http link. In an illustrative example, a text-to-speech component (not shown) may be responsible for converting, via speech-to-text functionality, a written or visual full output response produced by the token-output mapping module 110 into corresponding audio data that represents the written or visual full output response (e.g., an audio utterance of a full website link). In these embodiments, such audio data may be presented using a sound device (e.g., a voice assistant speaker or a stereo system in an ego-machine). In some embodiments, such audio data may be helpful so that an ego-machine operator is able to keep their eyes on the road without having to read text. In some embodiments, a display component (not shown) may be responsible for transmitting the written or visual full output response produced by the token-output mapping module 110 to a display device (e.g., an LCD screen memory of an infotainment device), such as a display screen in an ego-machine. In this way, the operator or other user may alternatively or additionally view or read the produced outputs. In some embodiments, a combination of the language model(s) 104 and the token-output mapping module 110 performs any suitable language generation task, such as question-answering, text summarization, machine translation, or the like.

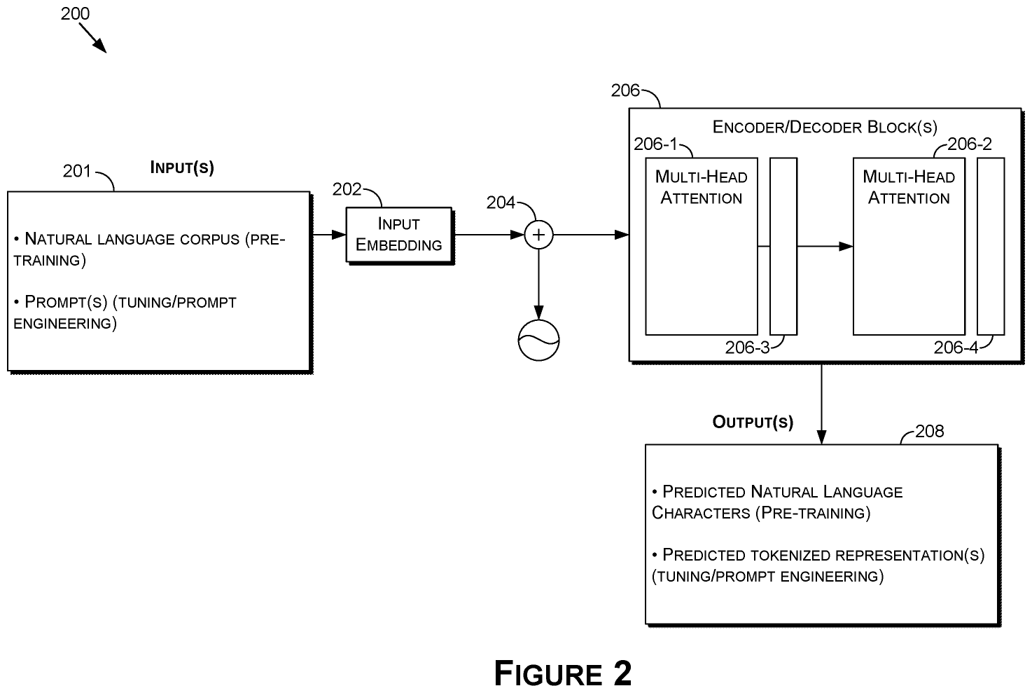

FIG. 2 is a block diagram of a Large Language Model 200 (e.g., a BERT model or GPT-4 model) that uses particular input(s) to generate particular tokenized representation(s), according to some embodiments. In some embodiments, this model 200 represents or includes the functionality as described with respect to the language model(s) 104 of FIG. 1. In various embodiments, the LLM 200 includes one or more encoders and/or decoder blocks 206 (or any transformer or portion thereof).

At a first time, the inputs 201 (e.g., the natural language input(s) 102 of FIG. 1) are converted into tokens and then feature vectors are embedded into an input embedding 202 (e.g., to derive meaning of individual natural language words (for example, English semantics) during pre-training). In some embodiments, each word or character in the input(s) 201 is mapped into the input embedding 202 in parallel or at the same time, unlike existing long short-term memory (LSTM) models, for example. The input embedding 202 maps a word to a feature vector representing the word. But the same word (for example, “apple”) in different sentences may have different meanings (for example, a device versus a piece of fruit). This is why a positional encoder 204 may be implemented. A positional encoder 204 is a vector that gives context to words (for example, “apple”) based on a position of a word in a sentence. For example, with respect to a message “I just sent the document,” because “I” is at the beginning of a sentence, embodiments may indicate a position in an embedding closer to “just,” as opposed to “document.” Some embodiments use a sign/cosine function to generate the positional encoder vector 204 as follows:

$$PE \_ ( ( pos , 2 i ) ) = sin ( pos / 10000 \hat{} ( 2 i / d \_model ) ⊣ )$$

$$PE \_ ( ( pos , 2 i + 1 ) ) = cos ( pos / 10000 \hat{} ( 2 i / d \_model ) ) ⊣$$

After passing the input(s) 201 through the input embedding 202 and applying the positional encoder 204, the output is a word embedding feature vector (e.g., a 1D numerical sequence), which encodes positional information or context based on the positional encoder 204. These word embedding feature vectors are then passed to the encoder and/or decoder block(s) 206, where it goes through a multi-head attention layer 206-1 and a feedforward layer 206-2. The multi-head attention layer 206-1 may be responsible for focusing or processing certain parts of the feature vectors representing specific portions of the input(s) 201 by generating attention vectors. For example, in Question Answering systems, the multi-head attention layer 206-1 determines how relevant the ith word (or particular word in a token) is for answering the question (e.g., “give me the link for Medicare”) or relevant to other words in the same or other blocks, the output of which is an attention vector. For every word, some embodiments generate an attention vector, which captures contextual relationships between other words in the same sentence or other sequence of characters. For a given word, some embodiments compute a weighted average or otherwise aggregate attention vectors of other words that contain the given word (for example, other words in the same line or sentence) to compute a final attention vector.

In some embodiments, a single headed attention has abstract vectors Q, K, and V that extract different components of a particular word. These are used to compute the attention vectors for every word, using the following formula:

$$Z = softmax ( Q \cdot K \hat{} T / √ ( Dimension of vector Q , K or V ) ) \cdot V$$

For multi-headed attention, there may be multiple weight matrices Wq, Wk and Wv, so there are multiple attention vectors Z for every word. However, a neural network may only expect one attention vector per word. Accordingly, another weighted matrix, Wz, may be used to make sure the output is still an attention vector per word. In some embodiments, after the layers 206-1 and 206-2, there is some form of normalization (for example, batch normalization and/or layer normalization) performed to smoothen out the loss surface making it easier to optimize while using larger learning rates.

Layers 206-3 and 206-4 represent residual connection and/or normalization layers where normalization re-centers and re-scales or normalizes the data across the feature dimensions. The feedforward layer 206-2 is a feed forward neural network that is applied to every one of the attention vectors outputted by the multi-head attention layer 206-1. The feedforward layer 206-2 transforms the attention vectors into a form that may be processed by the next encoder block or by making a prediction at 208. For example, given that a tokenized representation includes first natural language sequence “LINK . . . ” the encoder/decoder block(s) 206 predicts that the next natural language sequence will be an underscore symbol and 1 (“_1”) in the tokenized representation based on past tokenized representations that include language identical or similar to the first natural language sequence.

In some embodiments, the encoder/decoder block(s) 206 may be trained to learn language (pre-training) and make corresponding predictions. In some embodiments, the encoder/decoder block(s) 206 learns what language and context for a word is in pre-training by training on two unsupervised tasks-Masked Language Modeling (MLM) and Next Sentence Prediction (NSP)-simultaneously. In terms of the inputs and outputs, at pre-training, the natural language corpus of the inputs 201 may be various historical documents, such as textbooks, journals, web data, and/or periodicals in order to output the predicted natural language characters in 208 (not make the predictions at tuning/prompt engineering at this point). The encoder/decoder block(s) 206 takes in a sentence, paragraph, or sequence (for example, included in the input(s) d01), with random words being replaced with masks. The goal is to output the value or meaning of the masked tokens. For example, if a line reads, “please [MASK] this document promptly,” the prediction for the “mask” value is “send.” This helps the encoder/decoder block(s) 206 understand the bidirectional context in a sentence, paragraph. In the case of NSP, the encoder/decoder block(s) 206 takes, as input, two or more elements, such as sentences, lines, or paragraphs and determines, for example, if a second sentence in a document follows (for example, is directly below) a first sentence in the document. This helps the encoder/decoder block(s) 206 understand the context across all the elements of a document, not just within a single element. Using both of these together, the encoder/decoder block(s) 306 derives a good understanding of natural language during pre-training.

In pre-training, the output is typically a binary value C (for NSP) and various word vectors (for MLM). With training, a loss (for example, cross entropy loss) is minimized. In some embodiments, all the feature vectors are of the same size and are generated simultaneously. As such, each word vector may be passed to a fully connected layered output with the same number of neurons equal to the same number of tokens in the vocabulary.

In some embodiments, once pre-training is performed, the encoder/decoder block(s) 206 performs prompt engineering and/or tuning (e.g., prompt-tuning, and/or fine tuning). For example, for fine tuning, some embodiments perform a QA task by adding a new question-answering (e.g., a question-tokenized representation pair) head or encoder/decoder block in 306, just the way a masked language model head is added (in pre-training) for performing a MLM task, except that the task is a part of fine-tuning to add new input data in the input(s) 201 and adjust the weights formulated during pre-training. In other words, fine-tuning adds additional input data (i.e., the specific prompts in the input(s) 201 that are not part of pre-training), output tokens, and performs additional rounds of training to further adjust weights to formulate the output(s) 208 that are not part of pre-training. For example, with respect to question-tokenized representation pairs, some embodiments mask the tokenized representation to test the model's knowledge of what each sequence in the tokenized representation belongs to what prompt/question or use a form of NSP to predict the next tokenized representation in its entirety, as opposed to the next sentence or word, as would be done in pre-training.

Prompt engineering is the process of guiding and shaping ML model responses (e.g., the predicted tokenized representation(s) in the output(s) 208) by relying on the user, or prompt engineer, to craft more carefully phrased and specific queries or prompts. With prompt engineering, the weights are frozen (i.e., its values remain the same from pre-training) such that they are not adjusted during prompt engineering. A “prompt” as described herein may include one or more of: a natural language request (e.g., a question, command, or instruction (e.g., “write a summary of a poem”)), one or more datasets (e.g., a particular document or image), code snippets, mathematical equations, one or more examples (e.g., one-shot or two-shot examples), a hard prompt or template, and/or a numerical embedding (e.g., a “soft” prompt). In some embodiments, an “example” is indicative of few-shot prompting, which is a technique used to guide large language models (LLMs), like GPT-3, towards generating desired outputs by providing them with a few examples of input-output pairs.

The prompt engineering process often involves iteratively asking increasingly specific and detailed questions/commands/instructions or testing out different ways to phrase questions/commands/instructions. The goal is to use prompts to elicit better behaviors or outputs (e.g., tokenized representations) from the model. Prompt engineers may experiment with various types of questions/commands/instructions and formats to find the most desirable and/or relevant model response tokens. For example, a prompt engineer may initially provide a prompt (e.g., “who is the President”), where the tokenized representation is “Pres_CoA” (representative of a president of company A). However, this may not be specific enough/or may be the wrong tokenized representation, so the prompt engineer may formulate another prompt template that states, “who is the President of the United States” and the response token may be “Pres_AM” (representative of the President of the United States). The prompt engineer may be satisfied with this prompt. Subsequent to this satisfactory answer, particular embodiments save the corresponding event data prompt as a template. In this way, the prompt template (e.g., a “hard” prompt) may be used at runtime or when the model is deployed.

Prompt tuning is the process of taking or learning the most effective prompts or cues (among a larger pool of prompts) and feeding them to the encoder/decoder block(s) 206 as task-specific context. For example, a common question or phrase—“What is my account balance?”—could be taught to the encoder/decoder block(s) 206 to help optimize the model and guide it toward the most desirable decision or corresponding outputs in 208. Unlike prompt engineering, prompt tuning is not about a user formulating a better question/command or making a more specific request. Prompt tuning means identifying more frequent or important prompts (e.g., which have higher node activation weight values) and training the encoder/decoder block(s) 206 to respond to those common prompts more effectively with tokens. The benefit of prompt tuning is that it may be used to modestly train models without adding any more input(s) 201 or prompts (unlike fine-tuning), resulting in considerable time and cost savings.

In some embodiments, prompt tuning may use soft prompts only, and may not include the use of hard prompts. Hard prompts are manually handcrafted text prompts (e.g., prompt templates) with discrete tokenized tokens, which are typically used in prompt engineering. Prompt templating allows for prompts to be stored, re-used, shared, and programmed. Soft prompts are typically created during the process of prompt tuning. Unlike hard prompts, soft prompts are typically not viewed and edited in text. Soft prompts typically include an embedding, a string of numbers that derives knowledge from the encoder/decoder block(s) 206 (e.g., via pre-training). Soft prompts are thus learnable tensors concatenated with the input embeddings that may be optimized for a dataset. In some embodiments, prompt tuning creates a smaller light weight model (e.g., not the LLM 200) which sits in front of the frozen pre-trained model (i.e., the LLM 200 with weights set during pre-training). Therefore, prompt tuning involves using a small trainable model before using the LLM 200. The small model is used to encode the text prompt and generate task-specific virtual tokenized tokens. These virtual tokenized tokens are pre-appended to the prompt and passed to the LLM 200. When the tuning process is complete, these tokenized virtual tokens are stored in a lookup table (or other data structure) and used during inference, replacing the smaller model.

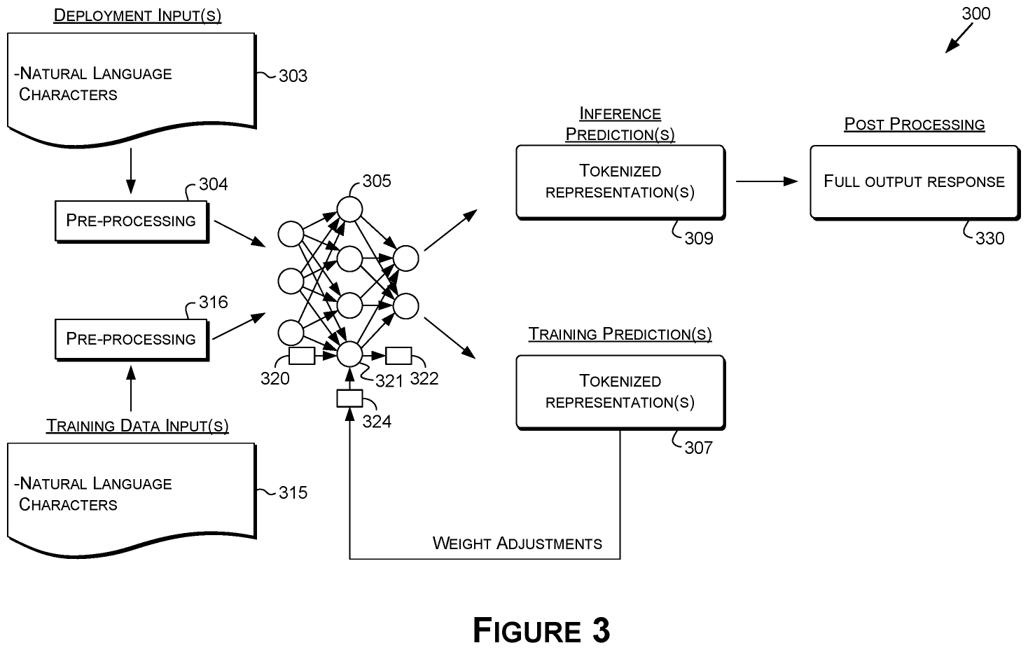

FIG. 3 is a schematic diagram illustrating how a neural network 305 generates a tokenized representation, according to some embodiments. In some embodiments, the neural network 305 represents what is used by or included in the language model(s) 104 of FIG. 1 and/or the LLM 200 of FIG. 2. In some aspects the neural network 305 represents or includes any suitable model functionality, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

The neural network 305 is modeled as a data flow graph (DFG), where each node (e.g., 321) in the DFG is an operator with one or more input and output tensors, such as 320 and 722. A “tensor” (e.g., a vector) is a data structure that contains values representing the input, output, and/or transformations processed by the operator. Each edge of the DFG depicts the dependency between the operators. Neural network 305 includes an input layer, an output layer and one or more hidden layers. An Input layer is the first layer of the neural network 305. The input layer receives pre-processed (e.g., via the pre-processing 304 or 316) input data represented by 303 and 315, such as one or more natural language characters (e.g., a question). The Output layer is the last layer of neural network 305. The output layer generates one or more inferences in the form of clustering, regression, classifications, or the like, which can either be hard classification (e.g., the tokenized representation is “LINK_1”) or soft probabilities (e.g., 50% likely that the tokenized representation is “LINK_1”), which is represented by the predictions 309 and 307. Neural network 305 may include any number of hidden layers. Hidden layers are intermediate layers in neural network 705 that perform various operations.

Each node in FIG. 3, such as node 321, is associated with or includes one or more activation tensors, such as input tensor 320, output tensor 322, and/or intermediate tensors. An “activation tensor” is a tensor that is an input, intermediate, and/or output to at least one neural network layer (e.g., as modeled going from left to right), as illustrated by the flow of data from input tensor 320 to output tensor 322. This is different than a weight tensor, such as 324, where weight tensors are modeled as flowing upward (not being actual inputs or outputs). In other words, activation tensors represent some form of the neural network inputs 303 and 315. For example, the input tensor 320 or node 321 can represent whether particular words were present in an input, whereas a weight tensor represents the weight values indicating node activation/inhibition values.

Each node in the network 305 may also be associated with or include and/or one or more weight tensors (e.g., 324), which include weight values. A “weight” in the context of machine learning may represent the importance or significance of a feature or feature value for prediction. For example, each feature (e.g., particular words of the input(s) 315) may be associated with an integer or other real number where the higher the real number, the more significant the feature is for its prediction. In one or more aspects, a weight in a neural network represents the strength of a connection between nodes or neurons from one layer (an input) to the next layer (a hidden or output layer). A weight of 0 may mean that the input (e.g., the input tensor 320) will not change the output (e.g., the output tensor 322), whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores. For example, particular natural language sequences (e.g., “Medicare”) may be highly correlated with a specific tokenized representation, and so neural network layers or nodes representing “Medicare” may be weighted higher so that that this data is activated or taken into account when making a final prediction score/token.

Each node of the neural network 305 may additionally perform one or more functions using the activation tensors and weight tensors, such as activation functions, matrix multiplication, normalization, or the like. In some aspects, the nodes in the neural network 305 are fully connected or partially connected. In some aspects, node 321 applies a weight tensor 324 to the input tensor 320 via a linear operation (e.g., matrix multiplication, addition, scaling, biasing, or convolution). All other nodes in the neural network may perform identical functionality. In some aspects, the result of the linear operation is processed by a non-linear activation, such as a step function, a sigmoid function, a hyperbolic tangent function (tan h), and rectified linear unit functions (ReLU) or the like. The result of the activation or other operation is an output tensor 322 that is sent to a subsequent connected node that is in the next layer of neural network 305. The subsequent node uses the output tensor 322 as the input activation tensor to another node.

Each of the functions in the neural network 305 may be associated with different coefficients (e.g., weights and kernel coefficients) that are adjustable during training. For example, after preprocessing 316 (e.g., normalization, feature scaling and extraction) in various aspects, the neural network 305 is trained using one or more data sets of the preprocessed training data inputs 315 in order to make acceptable loss training predictions at the appropriate weights to set the weight tensors. This will help later at deployment time to make correct inference predictions 309.

In one or more aspects, learning or training (which also includes “tuning” as described herein) includes minimizing a loss function between the target variable (for example, a prediction indicating an incorrect tokenized representation) and the actual predicted variable/ground truth (for example, a prediction indicating a correct tokenized representation). Based on the loss determined by a loss function (for example, Mean Squared Error Loss (MSEL), cross-entropy loss, etc.), the loss function learns to reduce the error in prediction over multiple epochs or training sessions so that the neural network 305 learns which features and weights are indicative of the correct tokenized representations, given the inputs 315. Accordingly, it is desirable to arrive as close to 100% confidence in a particular classification or inference as much as possible so as to reduce the prediction error. In an illustrative example, the neural network 305 learns that for a given set of natural language characters A (e.g., “what is the source code to make a list of elements”), the correct classification is a particular list data structure indicated in PYTHON language.

Subsequent to a first round/epoch of training, the neural network 305 makes predictions with a particular weight value, which may or may not be at acceptable loss function levels. For example, the neural network 305 may process the pre-processed training data inputs 315 a second time to make another pass of predictions. This process may then be repeated over multiple iterations or epochs until the weight values in the weight tensors are adjusted and learned for optimal or correct predicted values (for example, by maximizing rewards and minimizing losses) and/or the loss function reduces the error in prediction to acceptable levels of confidence.

Continuing with FIG. 3, in some aspects, the neural network 305 is trained in a supervised manner using annotations or labels, which represent classifications using a classification model. In an illustrative example, in some aspects, training includes (or is preceded by) annotating/labeling training data 315 so that the neural network 305 learns associations between the features or weights and corresponding labels, which is used to change the weights/neural node connections for future predictions. For example, some embodiments receive a first set of natural language characters (e.g., a user question “what is the link to Medicare”) at a first time. Responsively, subject matter experts or programming logic then label such question with a particular tokenized representation (e.g., “LINK_1”). Such process can be repeated for various subsequent times, natural language characters, and tokenized representations so that relationships between different tokenized representations and natural language characters can be learned. Specifically, the neural network 305 can learn which weights or features (e.g., words in a user question, such as “Medicare”) and their corresponding natural language sequences (e.g., user questions or commands) are indicative of a particular tokenized representation. As such, the neural network 305 accordingly adjusts the weights (the weight tensors) or deactivates nodes such that certain nodes corresponding to certain natural language characters (e.g., “Medicare”) are activated and other nodes corresponding to other natural language characters (e.g., “CIGNA”) are inhibited to make the training prediction(s) 307.

In one or more aspects, subsequent to the neural network 305 training, the neural network 305 (for example, in a deployed state) receives one or more of the pre-processed deployment input(s) 303. When a machine learning model is deployed, it has typically been trained, tested, and packaged so that it can process data it has never processed. Responsively, in one or more aspects, the deployment input(s) 303 (i.e., the set of natural language characters 303) are fed to the neural network 305, which then uses the same weight tensors (e.g., 324) that were learned via training so that the neural network 305 can produce the correct inference predictions 309. For example, the input tensor 320 can include new values (e.g., new words indicated in 303), which is then multiplied or otherwise combined with the weight tensor 324, representing the same weight values learned at training, in order to make the inference prediction(s) 309.

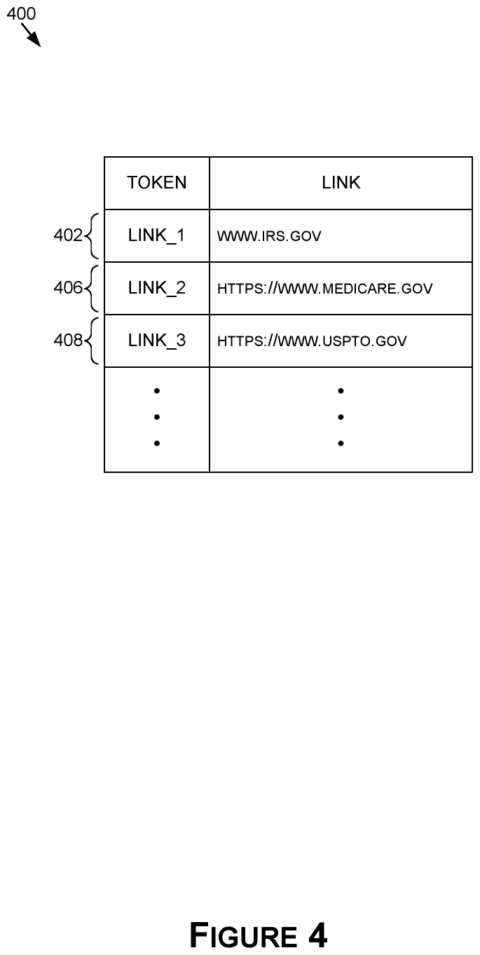

In some embodiments, the deployment input(s) 303 and/or the training data input(s) 315 represent or include the input(s) (e.g., the prompt(s)) 201 of FIG. 2 and/or the natural language input(s) 102 of FIG. 1. In some embodiments, the inference prediction(s) 309 and/or the training prediction(s) 307 represent what is generated by the token generator 108 of FIG. 4 and/or represent or includes the predicted token(s) indicated in the output(s) 208 of FIG. 2.

As illustrated in FIG. 3, after inference time (i.e., the inference prediction(s) 309), particular embodiments perform post-processing 330 to derive a full output response. For example, referring back to FIG. 1, the post-processing 330 may include all the functionality of the token-output mapping module 110 to map (e.g., via token-output data structure(s) 112) token(s) represented by the tokenized representations indicated in the inference prediction(s) 309 to a full output response 330, such as a second set of natural language characters (e.g., a full Medicare link https://www.medicare.gov).

FIG. 4 illustrates an example data structure 400 used for mapping a token to a full output response or set of content, according to some embodiments. In some embodiments, the data structure 400 represents what is included in the token-output data structure(s) 112 of FIG. 1. In some embodiments, the data structure 400 represents a hash table or other reference table (e.g., a lookup table) in order to map a token to a link (the full output response) and/or the link to the token.

The data structure 400 includes a “token” column that contains each token and a “LINK” column that contains each corresponding link. The data structure 400 includes three entries or records—entry 402, entry 406, or entry 408—which allows for a mapping between any token and its corresponding full output response. For example, in some embodiments, the data structure 400 represents a hash or reference table (e.g., a lookup table), where the key is defined by the “token” column and the values are the links. Accordingly, for instance, in response to the token-output mapping module 110 receiving the generated tokenized representation from the token generator 108, such as “LINK_1,” the token-output mapping module 110 performs a computer search for the matching “LINK_1” string (i.e., the token) in the data structure 402. Responsively, particular embodiments engage in a computer read of the entry 402 to derive this token's value, which is www.irs.gov. After retrieving such a link, the token-output mapping module 110 returns this link to the output presentation component 120 of FIG. 1.

Although the data structure 400 is represented by specific tokens and outputs, as well as a specific data structure format, it is understood that the tokens and outputs can additionally or alternatively contain other information and/or the data structure 400 can be structured differently. For example, with respect to structure, the data structure 400 may additionally or alternatively represent a link index or index table, such as {“www.irs.gov”: “LINK_1”, “https://www.medicare.gov”: “LINK_2”, “https://www.uspto.gov”: “LINK_3”, . . . }. An index data structure is a way of organizing and storing data to enhance the speed of data retrieval operations on a database or in a file system. It works as a pointer or reference to the actual data in a more efficient manner. Indexes are typically created on columns in database tables or on keys in file systems. Other examples of the data structure 400 are associative arrays, hash maps, or the like. Below is an illustrative example of PYTHON code that maps a machine-model generated token to a full output-a full link. The token is the key field and the full link is the value field in an associative array:

# Create an empty dictionary
links = { }
# Add some key-value pairs
links[“LINK_1”] = “https://www.irs.gov”
links[“LINK_2”] = “https://www.medicare.gov”
links[“LINK_3”] = “https://www.uspto.gov”
# Print the dictionary
print(links)
# Output: {‘LINK_1’: ‘https://www.irs.gov’,
‘LINK_2’: ‘https://www.medicare.gov’,
‘LINK_3’: ‘https://www.uspto.gov’}
# Get the full link for “LINK_2”
full_link = links[“LINK_2”]
# Print the full link
print(full_link)
# Output: https://www.medicare.gov

#Output: {′LINK_1′: ‘https://www.irs.gov’, ‘LINK_2’: ‘https://www.medicare.gov’, ‘LINK_3’: ‘https://www.uspto.gov’}
#Get the full link for “LINK_2”
full_link=links [“LINK_2”]
#Print the full link
print(full_link)
#Output: https://www.medicare.gov
   This Python source code sequence illustrates mapping a token to its full response by deriving the full link for “LINK_2” by using the key “LINK_2” to access the value (https:///www.medicare.gov) in the associative array. With respect other information, the “link” column can alternatively contain other immutable content, such as predefined factual information (e.g., president of US), predefined text (e.g., a poem), source code, or an image.

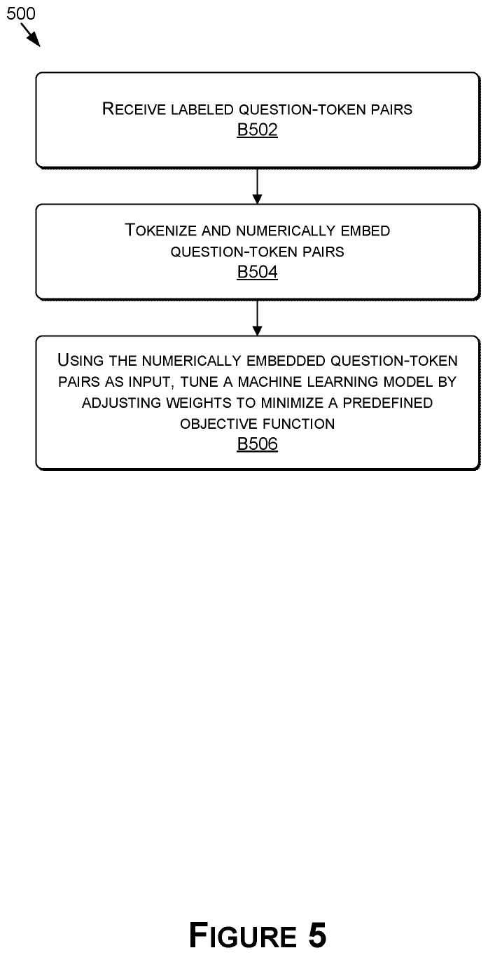

FIG. 5 is a flow diagram of an example process 500 for training a machine learning model to produce a tokenized representation, according to some embodiments. In some embodiments, the processing 500 is how the language model(s) 104, the LLM 300, and/or the neural network 305 is trained to generate a tokenized representation. Per block 502, some embodiments first receive labeled question-token pairs. A “question-token pair” refers to a particular question (or other input, such as a command) in a dataset that has been labeled with a particular tokenized representation. For example, referring back to FIG. 4, the question “where can I find federal tax information” can be labeled with the tokenized representation “LINK_1.” In some embodiments, human annotators (and/or computers) generate the pairs by providing questions and corresponding tokenized representations or answers. This annotation can be done by experts or crowdsourced workers who understand the context and can create meaningful pairs. The “question” datasets may come from various sources, including forums, QA websites, books, customer support logs, or specially curated datasets designed for QA tasks. However, because tokens may not be natural answers to questions, programmers or other users may have to hand-code such tokens and make them pair up with a question.

Per block 504, some embodiments then tokenize and numerically embed the question-token pairs. “Tokenization” is the concept of converting natural language text into tokens (words or subwords in this context). For example, for the question-token pair of “where can I find tax information—LINK_1” the tokenized form may be “where” “can” “I” “find” “tax” “information” “LINK_1.” In some embodiments, the tokenized representation (e.g., “LINK_1”) of the question-token pairs at block 502 is always a single token or word and is not broken up further. After tokenization at block 504, some embodiments responsively convert the tokenized representations into numerical embeddings (vectors) using techniques like word embeddings (Word2Vec, GloVe) or contextual embeddings (BERT, GPT) to represent the semantics and context of the text. This effectively structures the data in a format suitable for the machine learning model's input requirements.

It is understood that the term “token” in the context of question-token pairs or the tokenized representation that the token generator 108 generates is not a token in terms of tokenization. Rather, a “tokenized representation” represents an entire output sequence of a model, whereas a tokenized token as described with respect to block 504 refers to only a portion, such as a word, of an input to the model. When describing such tokenizing of tokens functionality, the term “tokenized token” will be used herein. It is also understood that the term token in the context of question-token pairs or the tokenized representation that the tokenized representation generator 108 generates does not represent a model input via a number in a numerical embedding (vector), such as via Word2Vec. Numerical embeddings represent tokenized tokens (i.e., the input) as numbers, whereas a “tokenized representation” as described herein represents an entire output, set of content, or natural language characters response of the model.

Per block 506, using the numerically embedded question-token pairs as input, some embodiments tune (e.g., fine-tune or prompt-tune after pre-training) a machine learning model by adjusting weights to minimize a predefined objective function. For example, using the question-token pairs as ground truth and given a question as input, the model may predict a particular tokenized representation as an output response to the given question. The model can then compare its prediction with the actual correct tokenized representation in the question-token pairs and adjust its parameters to minimize the error. In this way, the model can learn to answer questions that are similar to the ones in the training data with the correct tokenized representations. Specifically, the training objective is for the machine learning model to predict the tokenized representation given a question sequence. During tuning, the model minimizes a loss function that measures the difference between predicted tokenized representations and the actual tokenized representations in the answer sequence (e.g., in the question-token pairs). The model's parameters or weights may be updated/adjusted through techniques like backpropagation and optimization algorithms (e.g., Adam, SGD) to minimize the loss and improve the model's ability to generate accurate tokenized representations. Tuning can occur over multiple iterations (epochs) with batches of question-token pairs fed into the model to adjust its parameters/weights gradually.

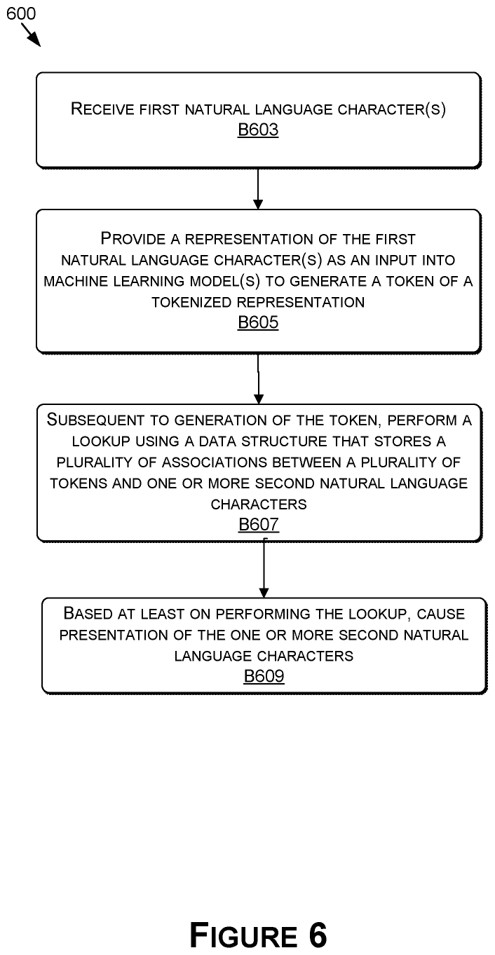

FIG. 6 is a flow diagram of an example process 600 for using a token to present an output response via one or more machine learning models, according to some embodiments. Per block 603, some embodiments first receive one or more first natural language characters (e.g., the natural language input(s) 102 of FIG. 12, the prompt(s) of the input(s) 201 of FIG. 2, and/or the deployment input(s) 303 of FIG. 3). The one or more first natural language characters represent any natural language sequence issued by a user and/or generated by a machine, such as a question, command, instruction, prompt, and/or the like.

Prior to the receiving of the one or more first natural language characters at block 603, some embodiments generate the data structure (e.g., at build-time), where the data structure includes a plurality of tokens that each represent a respective link, and where the data structure stores a plurality of associations between a plurality of tokens and one or more natural language characters or other set of content. For example, as described with respect to FIG. 1, the token-output data structure generator 114 may generate the data structure 400 “offline,” before a user issues a question/command, before runtime/model inference time, or the like.

Per block 605, some embodiments provide a representation (e.g., a soft prompt number or natural language) of the one or more first natural language characters as an input (e.g., an entire prompt) into the one or more machine learning models to generate a token of a tokenized representation, where the tokenized representation is an identifier that represents a token and/or is representative of an output or set of content (e.g., one or more second natural language characters). As described above, a “tokenized representation” or token represents an entire output sequence/response of the one or more machine learning models. For example, a token can be less than a 10-character string sequence, a hash, a “key” in a key-value pair structure, or the like. In some embodiments, the token or tokenized representation does not include a same character sequence as the output or set of content. For example, referring back to FIG. 4, the token “LINK_1” does not include a same character sequence as the link “www.irs.gov.” Such link contains a higher quantity of letters relative to the token, different letters relative to the token, and no numbers relative to the token, which contains the number 1. Put another way, in this example, the token or tokenized representation is a representation of the output, but includes different content (e.g., letters, numbers, symbols, spacing, etc.) than the output. In some embodiments, the token or tokenized representation is a condensed representation of the output (e.g., contains fewer characters, such as letters, relative to the output). Alternatively, in some embodiments, the token or tokenized representation has more characters relative to the output. For example, the output may be represented by a phrase with 10 characters, and the token may be a hash of 64 characters. As described above, a token may not be the same as a tokenization token (e.g., words of an entire input) or numerical embedding representing an input.

In some embodiments, a model, such as a language model described herein, generates the tokenized representation based on an input prompt, described, for example, with respect to the LLM 200 of FIG. 2. For example, the language model may generate the identifier “LINK_2.” And subsequent to the generation of the token and/or tokenized representation, some embodiments perform the lookup using the data structure as described with respect to block 607.

In some embodiments the representation of the one or more first natural language characters at block 605 includes a question or command to provide a link (e.g., “what is the link for Medicare?”). And the output may include the link itself as a response to the question or command. For example, the output can include the link “www.medicare.gov.” A “link” as described herein refers to a reference or connection between two resources (e.g., a user chat page of a first website (where the one or more first natural language characters are received) and a landing page of a second website). In some embodiments, a link is or includes a URL, a piece of text, an image, and/or any other element that, when clicked or activated, directs a user to another location, either within the same document or to an external resource, such as a webpage, a file, or an image. A URL (Uniform Resource Locator) is a specific type of link. A URL may be the address of a web resource, such as a website, a specific page on a website, a file, an image, or any other resource on the internet. It may include several parts, including the protocol (like http://or https://), the domain name (such as www.example.com), and the path to the specific resource.

In some embodiments, a link may be any suitable type, such as a hyperlink, internal link, external link, anchor link, image link, download link, or the like. The URL/link protocol may be any suitable protocol, such as HTTP, HTTPS (Hypertext Transfer Protocol Secure, FTP (File Transfer Protocol), SMTP (Simple Mail Transfer Protocol), POP3 (Post Office Protocol version 3), IMAP (Internet Message Access Protocol), DNS (Domain Name System), or SSH (Secure Shell).

In some embodiments, the “output” refers to the data that is presented at block 609 that represents the token or tokenized representation, and/or is otherwise produced at a final operation. In some embodiments, the “output” is not itself generated or produced by the one or more machine learning models. In some embodiments, the output includes one or more of, a link, source code, predefined factual information, predefined text, or an image. “Source code” refers to the human-readable instructions or statements written in a programming language. Source code may be the original version of a program that developers write using a specific programming language like Python, Java, C++, etc. It may contain comments, variable names, functions, and/or other constructs that make it understandable to programmers. Object code, on the other hand, is the output generated by a compiler or an interpreter after translating the source code into a machine-readable format. It is not easily understandable by humans and contains binary code (1s and 0s) or a lower-level representation of the program.

“Predefined factual information” as described herein refers to any fact or data known or occurring before block 603. For example, predefined factual information can be or include, mathematical equations, historical facts (e.g., President of the USA), email addresses, home addresses, phone numbers, scientific principles (e.g., what DNA includes), weather data, or the like. “Predefined text” as described herein refers to any character sequences known or generated before block 603, such as books, poems, scientific journal articles, chats, emails, blog posts, or the like. An “image” may refer a digital photograph, such as a rasterized image with pixels or a vector graphics image represented by various Bézier curves. In each of these use cases, the output may represent immutable predefined content that should not be parsed, broken apart, or changed when a model generates its output. “Immutable content” as described herein refers to content that when changed, such as via hallucination, causes the output response to become invalid (e.g., changing one number in an address causes the address to not exist). Accordingly, various embodiments keep the entire output (e.g., the full address) together by mapping the token to the output, as described with respect to block 607.

In some embodiments, the one or more machine learning model(s) that generate the tokenized representation are tuned (prior to the process 600) by learning a relationship between a prompt (e.g., a question) associated with the one or more first natural language characters (e.g., a similar question) and the tokenized representation. For example, such “learning” can include the process 500 as described with respect to FIG. 5. In some embodiments, this means that the one or more machine learning models do not learn a relationship between the prompt and the output (e.g., one or more second natural language characters) itself or refrain from learning such relationship. For example, as illustrated in FIG. 3, during training the neural network 305 only learns which tokenized representation(s) (i.e., training prediction(s) 307) belong to the natural language character(s) (i.e., the training data input(s) 315), but do not learn which full output responses in 330 (i.e., the post-processing step) belongs to the natural language character(s) in 315.

Per block 607, subsequent to the generating of the token, some embodiments perform a lookup using a data structure that stores a plurality of associations between a plurality of tokens and one or more second natural language characters or other set of content. For example, referring back to FIG. 4, some embodiments map the token “LINK_1” (the token) to “www.irs.gov” (the set of content) using the data structure 400 (e.g., via a lookup function of the key “LINK_1”), where the data structure 400 stores other associations between multiple tokens and other natural language characters. In some embodiments, such “data structure” includes at least one of, an index table, a hash table, a lookup table, or a pointer between the token and the output. An index table contains pointers or references to the actual data. A hash table is a data structure that uses a hash function to map keys to values. A lookup table is a general term for any data structure that maps keys to values using some function or algorithm. Both index tables and hash tables are examples of lookup tables, but there are other types as well, such as binary search trees, trie, or radix trees. In many data structures like dictionaries or hash maps, a pointer is implicit within the structure itself. When a value is accessed using a key, the structure may internally navigate or use pointers to locate and retrieve the associated value efficiently.

Per block 609, based at least on performing the lookup at block 607, some embodiments cause (e.g., audio or visual) presentation of the output. In some embodiments, the output is caused to be presented and actually presented but the token or tokenized representation is not caused to be presented. For example, a central server may instruct a user device to visually display a full output response link (the output) and the link is provided to a display screen of the user device, but the token is not displayed or embodiments otherwise refrain from displaying such token. This is because end-users may not be concerned about or otherwise need to know the contents of the token/tokenized representation, since the user did not request such token/tokenized representation but only the output from the one or more first natural language characters. In an illustrative example, a user may issue a command (e.g., the one or more first natural language characters), such as “give me the link so I can file patents.” Responsively, blocks 605, 607, and 609 are performed, where only the link (e.g., “www.uspto.gov” is presented to the user device but not the token, since that is not what the user asked for.

In some embodiments, the displayed link at block 609 is a hyperlink, meaning that it is selectable to direct the user to another resource, such as a different web page indicated in the link. When a web developer creates a hyperlink, for example, they may use HTML code to define it. The HTML <a> (anchor) tag may be used to create hyperlinks. Within this tag, they specify the destination URL (Uniform Resource Locator), which is the address of the webpage or resource to which the hyperlink will direct users. When the webpage containing the hyperlink is loaded in a web browser (e.g., is displayed at block 609), the browser may interpret the HTML code and render the content. The hyperlink may appear as clickable text or an image, styled according to the webpage's design. When a user clicks on the hyperlink (e.g., subsequent to block 609), the web browser recognizes the user's action as a request to navigate to the URL specified in the hyperlink's href attribute. The browser may then initiate a request to a server hosting the destination URL. It may send an HTTP request (e.g., a GET request) to that server asking for the content located at the specified URL. The server may then responsively process the request and generate an HTTP response. This response may contain the HTML, CSS, JavaScript, images, or any other resources required to render the destination webpage. The browser may then receive the response from the server. If the response is successful (e.g., status code 200 OK), the browser may start to render the content received from the destination URL. This content might include text, images, videos, and other media elements as specified by the webpage's code. Finally, the browser may display the content of the destination webpage to the user device, replacing the current webpage with the new one (indicative of the user being brought to the new web page after clicking the hyperlink).

In some embodiments, block 609 additionally or alternatively includes causing presentation of a sequence of text corresponding to and/or associated with the tokenized representation. For example, if the tokenized representation is “LINK_2” and the set of content in the data structure is “www.medicare.gov,” the sequence of text may be, “If you want to see your Medicare information, got to . . . ” In some embodiments, the presentation of a subset of the text from the sequence of text that corresponds to the at least one token includes presentation of the set of content (e.g., www.medicare.gov). In other words, the sequence of text or full output response that a user sees is the following sentence, “If you want to see your Medicare information, go to www.Medicare.gov.”

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), one or more occupant monitoring system (OMS) sensor(s) 701 (e.g., one or more interior cameras), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

Cameras with a field of view that include portions of the interior environment within the cabin of the vehicle 700 (e.g., one or more OMS sensor(s) 701) may be used as part of an occupant monitoring system (OMS) such as, but not limited to, a driver monitoring system (DMS). For example, OMS sensors (e.g., the OMS sensor(s) 701) may be used (e.g., by the controller(s) 736) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 716 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(D) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

In an example embodiment, one or more processors comprise: one or more processing units to: provide a representation of one or more first natural language characters as an input into one or more machine learning models to generate a token of a tokenized representation; subsequent to generation of the token, perform a lookup using a data structure that stores a plurality of associations between a plurality of tokens and one or more second natural language characters; and based at least on performing the lookup, cause presentation of the one or more second natural language characters.

In some embodiments, the representation of the one or more first natural language characters provided as input into one or more machine learning models includes a question or command to provide a link, and wherein the one or more second natural language characters that are represented by the token and retrieved via the data structure include the link as a response to the question or command.

In some embodiments, the association between the token and the one or more second natural language characters is stored using the data structure, the data structure being implemented to include at least one of an index table, a hash table, a lookup table, or a pointer.

In some embodiments, the token generated using the one or more machine learning models comprises a condensed representation of the one or more second natural language characters.

In some embodiments, the one or more processing units are further to generate, prior to the receiving of the one or more first natural language characters, the data structure, and wherein the data structure stores a plurality of associations between a plurality of tokens that each represent a respective link.

In some embodiments, the one or more processing units are further to tune the one or more machine learning models by learning a relationship between a prompt associated with the one or more first natural language characters and the token.

In some embodiments, the one or more second natural language characters represented by the token and retrieved from the data structure include at least one of: a link, source code, predefined factual information, or predefined text.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In an example embodiments, a system comprises one or more processing units to: generate, using a language model, a tokenized representation based on an input prompt; perform a lookup using at least one token of the tokenized representation to determine a set of content corresponding to the at least one token; and cause a presentation of a sequence of text corresponding to the tokenized representation, wherein the presentation of a subset of text from the sequence of text that corresponds to the at least one token includes a presentation of the set of content.

In some embodiments, the input prompt includes a question or command to provide a link, and wherein the sequence of text includes the link as a response to the question or command, and wherein the tokenized representation is a unique identifier representing the link.

In some embodiments, the one or more processing units are further to: subsequent to generating the tokenized representation, retrieve, via a data structure, the set of content; and based at least on the retrieve, via the data structure, of the set of content, cause a presentation of a sequence of text corresponding to the tokenized representation.

In some embodiments, the lookup is performed using at least one of an index table, a hash table, a lookup table, and a pointer between the token and the set of content.

In some embodiments, the tokenized representation generated using the language model is a condensed representation of the set of content.

In some embodiments, the one or more processing units are further to generate, prior to performing the lookup, a data structure, and wherein the data structure includes a plurality of tokens that each represent a respective link.

In some embodiments, generating the token is indicative of at least partially tuning the language model by learning a relationship between the set of content and the token.

In some embodiments, generating the set of content includes at least one of: a link, source code, predefined factual information, predefined text, or an image.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In an example embodiment, a method comprises: generating, via one or more machine learning models, a tokenized representation; retrieving, via a data structure, a set of content by mapping a token of the tokenized representation to the set of content; and based at least on the retrieving, causing presentation of a sequence of text corresponding to the tokenized representation, wherein the presentation of a subset of text from the sequence of text that corresponds to the at least one token includes a presentation of the first set of content.

In some embodiments, the sequence of text includes a response to a question or command to provide a link, and wherein the subset of text from the sequence of text that corresponds to the at least one token includes the link as a response to the question or command.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

What is claimed is:

1. One or more processors comprising:
one or more processing units to:
provide a representation of one or more first natural language characters as an input into one or more machine learning models to generate a token of a tokenized representation;
subsequent to generation of the token, perform a lookup using a data structure that stores a plurality of associations between a plurality of tokens and one or more second natural language characters; and
based at least on performing the lookup, cause presentation of the one or more second natural language characters.

2. The one or more processors of claim 1, wherein the representation of the one or more first natural language characters provided as input into one or more machine learning models includes a question or command to provide a link, and wherein the one or more second natural language characters that are represented by the token and retrieved via the data structure include the link as a response to the question or command.

3. The one or more processors of claim 1, wherein the association between the token and the one or more second natural language characters is stored using the data structure, the data structure being implemented to include at least one of an index table, a hash table, a lookup table, or a pointer.

4. The one or more processors of claim 1, wherein the token generated using the one or more machine learning models comprises a condensed representation of the one or more second natural language characters.

5. The one or more processors of claim 1, wherein the one or more processing units are further to generate, prior to the receiving of the one or more first natural language characters, the data structure, and wherein the data structure stores a plurality of associations between a plurality of tokens that each represent a respective link.

6. The one or more processors of claim 1, wherein the one or more processing units are further to tune the one or more machine learning models by learning a relationship between a prompt associated with the one or more first natural language characters and the token.

7. The one or more processors of claim 1, wherein the one or more second natural language characters represented by the token and retrieved from the data structure include at least one of: a link, source code, predefined factual information, or predefined text.

8. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processing units to:
generate, using a language model, a tokenized representation based on an input prompt;
perform a lookup using at least one token of the tokenized representation to determine a set of content corresponding to the at least one token; and
cause a presentation of a sequence of text corresponding to the tokenized representation, wherein the presentation of a subset of text from the sequence of text that corresponds to the at least one token includes a presentation of the set of content.

10. The system of claim 9, wherein the input prompt includes a question or command to provide a link, and wherein the sequence of text includes the link as a response to the question or command, and wherein the tokenized representation is a unique identifier representing the link.

11. The system of claim 9, wherein the one or more processing units are further to:
subsequent to generating the tokenized representation, retrieve, via a data structure, the set of content; and
based at least on the retrieve, via the data structure, of the set of content, cause a presentation of a sequence of text corresponding to the tokenized representation.

12. The system of claim 11, wherein the lookup is performed using at least one of an index table, a hash table, a lookup table, and a pointer between the token and the set of content.

13. The system of claim 9, wherein the tokenized representation generated using the language model is a condensed representation of the set of content.

14. The system of claim 9, wherein the one or more processing units are further to generate, prior to performing the lookup, a data structure, and wherein the data structure includes a plurality of tokens that each represent a respective link.

15. The system of claim 9, wherein generating the token is indicative of at least partially tuning the language model by learning a relationship between the set of content and the token.

16. The system of claim 9, wherein the set of content includes at least one of: a link, source code, predefined factual information, predefined text, or an image.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

18. A method comprising:
generating, via one or more machine learning models, a tokenized representation;
retrieving, via a data structure, a set of content by mapping a token of the tokenized representation to the set of content; and
based at least on the retrieving, causing presentation of a sequence of text corresponding to the tokenized representation, wherein the presentation of a subset of text from the sequence of text that corresponds to the at least one token includes a presentation of the first set of content.

19. The method of claim 18, wherein the sequence of text includes a response to a question or command to provide a link, and wherein the subset of text from the sequence of text that corresponds to the at least one token includes the link as a response to the question or command.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.
